(19) United States
(12) Patent Application Publication
(10) Pub. No.: US 2002/0053019 A1
(43) Pub. Date: May 2, 2002

(54) System, computer product and method for secure electronic mail communication

(76) Inventors: Mel Burton Ruttan, Burlington (CA); Ronald Leslie Tubman, Lindsay (CA)

Correspondence Address: EUGENE J A GIERZAK, KEYSER MASON BALL, 201 CITY CENTRE DRIVE, SUITE 701, MISSISSAUGA, ONTARIO, L5B 2T4, CA

(21) Appl. No.: 09/984,108

(22) Filed: Oct. 29, 2001

Related U.S. Application Data
(60) Provisional application No. 60/243,716, filed on Oct. 30, 2000.

(51) Int. Cl. H04L 9/00

(52) U.S. Cl. 713/152

(57) ABSTRACT

A system, computer product and method for data communication between a first computer and a second computer is provided, wherein data is encrypted and provided in the body of any electronic mail message

### FIELD OF THE INVENTION

This invention relates in general to systems, computer products and methods for communicating data electronically via an interconnected network of computers. This invention still further relates to communication software for communicating data on an encrypted basis.

### BACKGROUND OF THE INVENTION

This invention relates to cryptography, that is the use of secret codes to maintain the privacy of communications exchanged in a medium where communications are susceptible to intrusion or interception.

Numerous systems, computer products and methods for providing data communication over an interconnected network of computers on a secure basis are known. In particular, numerous communication software products that provide secure data communication are known. For example, software products known as “PGP” of Network Associates, “SOLO” of Entrust Technologies Inc., as well as the computer products of RSA are directed at providing secure exchange of data between trusted parties.

A large volume of data is communicated to commercial and non-commercial users. For example, in the financial industry alone, such data comprises bank statements, investment portfolios and the like. Other data transferors who would benefit from use of an interconnected network of computers for transferring data include credit agencies, insurance companies, law firms, securities regulators, and the like. All of the foregoing are referred to herein as “Data Transferors”.

Electronic communication of such data over an interconnected network of computers such as the Internet is hindered by the absence of systems, computer products and methods for data communication on a secure basis. Alternatively, if such data is communicated electronically other than on a secure basis, then there is a risk of breach of security.

Prior art solutions, including those referred to above, do not address the particular requirements of data communication on a secure basis over an interconnected network of computers such as the Internet.

A problem with the application of current solutions to data communication over an interconnected network of computers such as the Internet, is the fact that such prior art solutions generally treat encrypted files as electronic mail attachments. This is especially the case where the recipients of data desire to use existing electronic mail software, rather than having to migrate to a new application for communication with a Data Transferor. The average customer of a Data Transferor would be adverse to migration to a new electronic mail software program. Particularly in recent days as a result of the spread of computer viruses to computer systems world wide via the Internet, restrictions have been placed on the acceptance. by host computers of electronic mail bearing computer file attachments, as most computer viruses are spread by means of such attachments. In addition, computer system firewalls also include file attachment restrictions for security reasons in many cases, as most computer “hacking” also occurs by means of uploading files to a web server using an attachment. Such restrictions affect the ability of a significant proportion of electronic mail users to receive electronic mail computer file attachments, and therefore files encrypted using the prior art solutions. Therefore, there is a need for a system, computer product and method for providing data communication on a secure basis over an interconnected network of computers that communicates encrypted data other than by means of computer file attachments.

Further, for the purpose of data communication over an interconnected network of computers such as the Internet to a customer base wherein some customers may not have significant computer skills, a computer product that is easy to use is required. In addition, for Data Transferors to take advantage of the cost savings of electronic communication of data to their clients, the effort required by their clients to adopt the new system, computer product and method for data communication must be minimal. To this end, a system, computer product and method for data communication is required wherein the computer product employed by the clients is easy to distribute to their customers.

### SUMMARY OF THE INVENTION

An object of one aspect of the present invention is to provide a system for data communication on a secure basis between a first computer and at least one other second remote computer comprising: an electronic mail means at each of said first computer and second remote computer for data communication therebetween by electronic mail; an encryption means at each of said first computer and second remote computer for encrypting and decrypting data communicated therebetween by said electronic mail means using an encryption key accessible from said encryption means at each of said first computer and second remote computer; and an interface means adapted to permit said encryption means and electronic mail means to interface; wherein said interface means and encryption means at said first computer are adapted to permit data to be encrypted with said encryption key and provided to said electronic mail means in the body of an electronic mail message; wherein said electronic mail means is adapted to communicate said electronic mail message to said second remote computer; and wherein said interface means and encryption means at said second remote computer are adapted to permit said electronic mail message to be decrypted using said encryption key.

Another object of the present invention is to provide a system for receiving data on a secure basis at a first computer from a second remote server computer comprising: an electronic mail means at said first computer adapted to receive electronic mail messages from said remote server computer; an encryption means at said first computer adapted to decrypt encrypted data using an encryption key accessible from said first computer; and an interface means adapted to permit said encryption means and electronic mail means to interface; wherein said interface means and encryption means are adapted to permit encrypted data received by said first computer from said second remote server computer in the body of said electronic mail message to be decrypted using said encryption key.

A still other object of the present invention is to provide system for delivering data on a secure basis to a plurality of computers comprising: a server computer connected to said plurality of computers via an interconnected network of computers; memory means comprising information regarding each of said plurality of computers, said information including electronic mail addresses corresponding to each of said plurality of computers, data for delivery to each of said plurality of computers, and an encryption key provided to each of said plurality of computers for encrypting data communicated between said server computer and each of said plurality of computers; an electronic mail means to send electronic mail messages comprising said data to said plurality of computer using said electronic mail addresses; an encryption means adapted to encrypt and decrypt data; and an interface means adapted to permit said encryption means and electronic mail means to interface; wherein said interface means and encryption means are adapted to permit said data to be encrypted in the body of said electronic mail messages, and decrypted from the body of said electronic mail messages; and said electronic mail means is adapted to send said electronic mail messages to said plurality of computers, and receive electronic mail messages from said plurality of computers.

A further object of the present invention is a computer product for receiving data on a secure basis at a first computer from a remote server computer comprising: a recording means; means recorded on said recording means for providing instructions to said first computer, wherein said first computer is adapted to provide: an encryption means adapted to encrypt and decrypt data communicated between said first computer and said remote server computer using an encryption key accessible from said first computer; and an interface means adapted to permit said encryption means to interface with an electronic mail means provided at said first computer for sending and receiving electronic mail messages; wherein said interface means and encryption means are adapted to permit said encrypted data received by said first computer in the body of an electronic mail message received by said electronic mail means to be decrypted using said encryption key.

A still further object of the present invention is a computer product for delivering data on a secure basis from a server computer to a plurality of computers, wherein said server computer and plurality of computers are connected via an interconnected network of computers, said computer product comprising: a recording medium; means recorded on said recording medium for providing instructions to said server computer such that said server computer is adapted to provide: a memory means comprising information regarding each of said plurality of computers, said information comprising electronic mail addresses corresponding to each of said plurality of computers, data for delivery to each of said plurality of computers, and an encryption key provided to each of said plurality of computers for encrypting data communicated between said server computer and each of said plurality of computers; an encryption means adapted to encrypt and decrypt data communicated between said server computer and said plurality of computer provided in the body of an electronic mail message; and an interface means adapted to permit said encryption means to it interface with an electronic mail means provided at said server computer for sending and receiving electronic mail messages between said server computer and said plurality of computers; wherein said interface means and encryption means are adapted to permit said data to be encrypted in the body of said electronic mail messages.

A still further object of the present invention is a method of communicating data on a secure basis from a first computer to a second remote computer, said method comprising the steps of: providing an electronic mail means at each of said first computer and remote computer for communication of electronic mail therebetween; providing an encryption means at each of said first computer and remote computer for encrypting and decrypting data communicated therebetween by said electronic mail means, using an encryption key accessible from each of said first computer and remote computer; sending an electronic mail message from said first computer to said remote computer by means of said electronic mail means, wherein data is encrypted by said encryption means at said first computer and provided to said remote computer in the body of said electronic mail message; decrypting said data from said body of said electronic mail message by means of said encryption means at said remote computer, using said encryption key.

### BRIEF DESCRIPTION OF THE DRAWINGS

A detailed description of the preferred embodiment(s) is (are) provided herein below by way of example only and with reference to the following drawings, in which:

FIG. 1 is a system resource flowchart illustrating the resources of the system of the present invention;

FIG. 2 is a program resource flowchart illustrating the resources of the computer product of the present invention;

FIG. 3 is a flowchart illustrating the functions executed by the computer product of the present invention.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

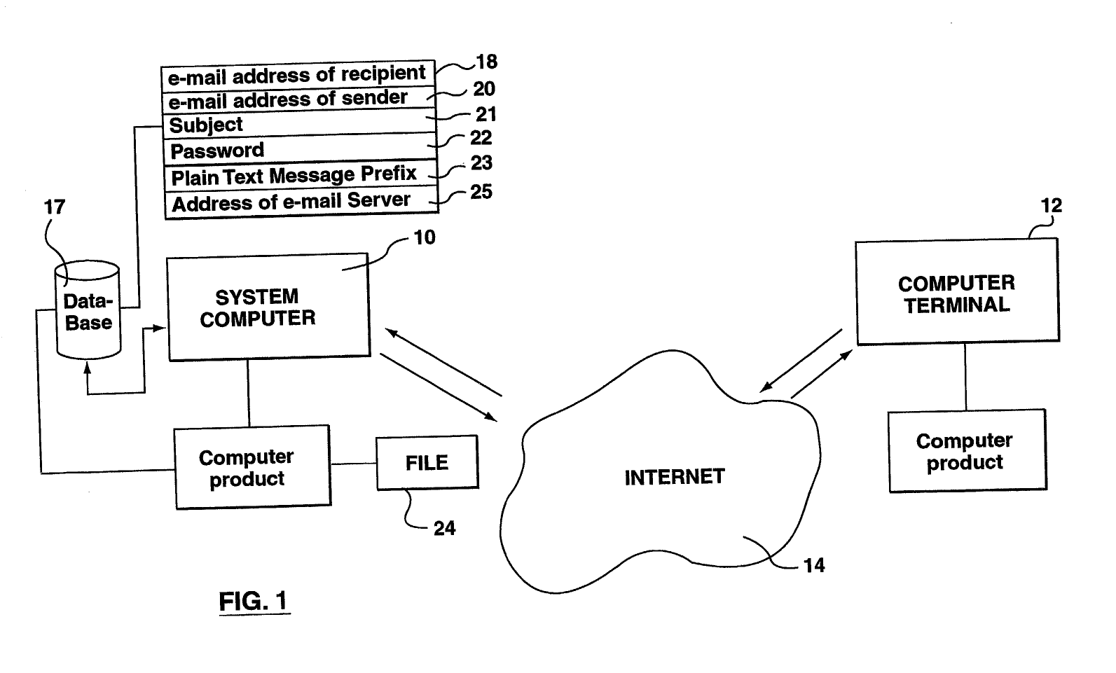

Referring to FIG. 1, there is illustrated in a system resource flowchart the resources of the system of the present invention. In a first preferred embodiment of the present invention, a server computer 10 is provided as well as at least one computer terminal 12 connected to an interconnected network of computers 14 such as the Internet. Server computer 10 comprises any form of computer possessing a microprocessor, but in the preferred embodiment of the present invention will generally comprise the server computer of a Data Transferor, providing or associated with a web server. Computer terminal 12 will comprise any type of computer likely to be used by a customer of a Data Transferor, whether such customer is an individual or a company. In this way, in the first preferred embodiment of the present invention, computer terminal 12 may comprise a server computer, personal computer, WAP enabled device or the like. Similarly server computer 10 may also comprise a server computer, personal computer, WAP enabled device or the like.

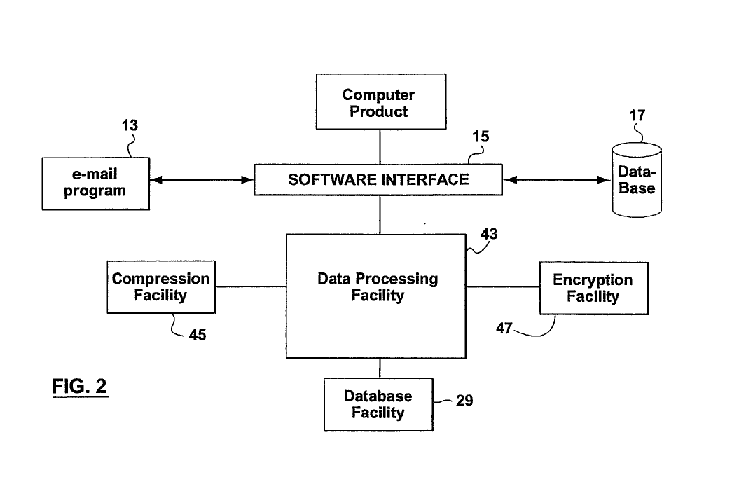

The system, computer product and method disclosed herein is directed at communicating data between server computer 10 and computer terminal 12 on a secure basis. To this end, both server computer 10 and computer terminal 12 are provided with the computer product(s) described herein. The resources of this computer product are best illustrated by FIG. 2.

The preferred embodiment of the computer product of the present invention comprises an encryption computer product that interfaces with a wide assortment of communication software products likely to be used by the user(s) associated with computer terminal 12, such as Outlook™, Groupwise™ or the like by means of software interface 15, as best shown in FIG. 2.

The computer product of the present invention is implemented to code in a manner that is well known and may employ a number of different encryption algorithms having regard to type or bit strength, in a manner that is well-known. In the preferred embodiment of the computer product of the present invention, the public domain encryption technology known as “BLOWFISH” is employed, in a manner that is well known.

One of the advantages of the preferred embodiment of the invention provided herein is that it has excellent security characteristics, while the size of the computer program is relatively small (approximately 0.26 megabytes—having regard to the base utilities described herein). This means that the computer product of the present invention can be distributed with relative ease, by means of a relatively short download time by customers over an interconnected network of computers such as the Internet, or even by attachment to electronic mail (by means of a self-executing program attachment), in a manner that is well known.

In the preferred embodiment of the present invention, a database 17 is associated with server computer 10, as shown in FIG. 1. This database comprises the e-mail address of the intended recipient of the document 18; e-mail address of the sender 20; optional plain text for the “subject” line of the e-mail message 21; the personal password 22 of each individual user (or group of users) associated with each computer terminal 12; optional displayed prefix message 23; and the path and filename of the file(s) to be encrypted 25.

In the preferred embodiment of the present invention, password 22 can comprise a password already used by each user (or group of users) associated with each computer terminal 12 (“User”), provided by separate communication such as by telephone or mail, or distributed by means of a secure key distribution method such as the key distribution method disclosed in the co-pending application Ser. No. 09/220,362. In accordance with the preferred embodiment of the present invention, password 22 comprises a symmetrical password key of up to 56 characters (448 bits) which is generated electronically, for example by derivation from User's logon password, in a manner that is well known

The operator of server computer 12 will have in its possession a file 24 which requires transfer to User. This file can be of a variety of file types of formats, for example, a WORD™ file, EXCEL™ spreadsheet or the like. The computer product of the present invention provides means for accessing the information from database 17 and providing such information to the appropriate fields in a communication software program, in a manner that is well known.

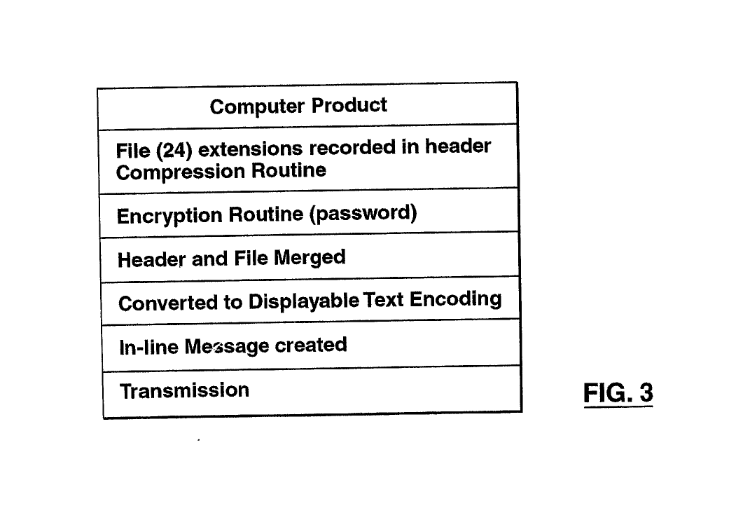

Having regard to server computer 12, the computer product of the present invention comprises a server application that is provided in a manner well known to a skilled computer programmer. The computer product of the present invention executes a number of functions at server computer 12 best illustrated in FIG. 3. First, file details or data processing commands 24 are recorded within the encrypted data. The data processing commands 24 are expressed, in a manner that is well known, such that they are understood by the computer product of the invention to be separate and apart from the document included in the encrypted data. These data processing commands 24 are adapted to instruct each computer terminal 12 as to the rules for processing the data sent to the computer terminal 12 by the server computer on an encrypted basis. In a particular embodiment of the present invention, the data processing commands 24 comprise a file extension required in order to select appropriate viewer applications at computer terminal 12, as is further particularized below. It should be understood, however, that the present invention contemplated the data processing commands 24 to further comprises such commands that are known by skilled programmers for manipulating data, publishing data, storing data to particular locations and so on.

Second, in the preferred embodiment of the present invention, file 24 is compressed by means of some form of known data compression, in a manner that is well known. Thirdly, file 24 is encrypted using password 22. Fourthly, the header and encrypted file 24 is merged and converted to displayable text encoding, in a manner that is also well known. This displayable text encoding, as particularized below is provided as an “in-line” message as opposed to an electronic mail attachment. Fifthly, the displayable text is transmitted to computer terminal 12 by means of the specified electronic mail server, in association with communication software program and database 17, in a manner that is known.

It should be mentioned in regard to the fifth function described above, that the preferred embodiment of the present invention employs the “SMTP” corporate electronic mail server standard. In addition, the above functions are provided by the computer product of the present invention by means of a number of well known software utilities, namely linkable object libraries, dynamic runtime libraries and standalone executable images.

Also, as best shown in FIG. 3, hereto, on the side of computer terminal 12, a number of functions are executed by the system, computer product and method of the present invention provided by or in association with the computer product of the present invention at computer terminal 12. The computer product of the present invention is provided by a suitable computer program, depending on the nature of computer terminal 12, i.e. whether computer terminal 12 is a server computer, personal computer or WAP enabled device. In either case, the computer program associated with computer terminal 12 is programmed in a manner that is well known to those skilled in the art.

Said computer program executed the following functions. First, User opens the electronic mail message received from server computer 10, as described above, with the communication software program located at computer terminal 12 used by User. The message is displayed as lines of apparently meaningless text in-line in the message, rather than as an attachment, as previously stated; optionally, by well-known methods, this scrambled text can be hidden so that o displayed to the user. It has been shown that users of the computer product of the present invention, outside of other practical advantages discussed herein, prefer the display of the encrypted message in this way because it constitutes palpable proof that the information received was encrypted before transmission, thus helping to allay security concerns.

The computer product of the present invention is then activated in a manner that is well known, for example, by activating an icon linked to the computer product of the present invention located in the Windows™ Toolbar. The computer product copies the garbled/encrypted text into a buffer area, in a manner that is well known. Then, the computer product of the present invention obtains User's personal password 22 either by means of an input field or from a secure passbook file provided by the computer product of the present invention at computer terminal 12, in a manner that is also well known. File 24 is then decrypted using password 22, along with the header, and the document is decompressed, if necessary, to its original size and content by means of compression/decompression software provided by the computer product of the present invention. Lastly, the original file extension referred to, is used to open User's preferred viewer located at computer terminal 12, thereby allowing User to view file 24, and/or manipulate same in a manner that is well known.

In this way, the computer product of the present invention is best understood by reference to FIG. 2. The computer product comprises a software interface 15 which interfaces with database 17 and also a communication application or e-mail program 13. In addition, the computer product of the present invention comprises a data processing facility 43 contains a series of routines for executing the functions described above. Data processing facility 43 provides the functions described above in association with compression facility 45, encryption facility 47 and database facility 29. Database facility 29 extracts data from database 17 such as the electronic mail address of the recipient 18 in order to provide the functions described above.

It should be understood from the above, that in view of the requirement of password 22 to decrypt an encrypted in-line message received at computer terminal 12, only messages from a known source will be decrypted. Such messages from known sources are unlikely to contain a malicious virus and therefore do not constitute a significant risk to computer security.

It should also be understood that the system, computer product and method of the present invention can be provided by a skilled programmer for a wide range of computer systems, networks, server platforms, operating systems, and in a wide range of computer programming languages, in a manner that is well known. In addition, the present invention can be provided to interface with or incorporate numerous other programs, such as compression/decompression programs, additional viewers, data management utilities and the like.

The present invention may co-operate with existing digital signature systems where additional user authentication is required, in a manner that is also well known.

Other variations and modifications of the invention are possible. For example, Through the use of API calls to dynamic link libraries (dll's) the present invention can be made available to system integrators to be embedded into custom designed applications. All such modifications or variations are believed to be within the sphere and scope of the invention as defined by the claims appended hereto.

We claim:

1. A system for data communication on a secure basis between a first computer and at least one other second remote computer comprising:
a) an electronic mail means at each of said first computer and second remote computer for data communication therebetween by electronic mail;
b) an encryption means at each of said first computer and second remote computer for encrypting and decrypting data communicated therebetween by said electronic mail means using an encryption key accessible from said encryption means at each of said first computer and second remote computer; and
c) an interface means adapted to permit said encryption means and electronic mail means to interface;
wherein said interface means and encryption means at said first computer are adapted to permit data to be encrypted with said encryption key and provided to said electronic mail means in the body of an electronic mail message;
wherein said electronic mail means is adapted to communicate said electronic mail message to said second remote computer; and
wherein said interface means and encryption means at said second remote computer are adapted to permit said electronic mail message to be decrypted using said encryption key.

2. A system as claimed in claim 1, wherein said electronic mail means at said second remote computer comprises a known electronic mail program and said interface means permits said encryption means at said second remote computer to interface with said electronic mail program so as to decrypt data within said body of said electronic mail message opened using said electronic mail program.

3. A system as claimed in claim 2, wherein said second remote computer further comprises a memory means for storing said encryption key and relating said encryption key to the electronic mail address of said first computer, wherein said encryption means is adapted to retrieve said encryption key corresponding to said first computer from said memory means based on said electronic mail address of said first computer and decrypting said electronic mail message using said encryption key.

4. A system as claimed in claim 3, wherein said electronic mail message further comprises:
a) a document; and
b) a data processing command that is adapted to trigger said interface means at said second remote computer to initiate at least one computer program at said second remote computer to process said document in accordance with said data processing command.

5. A system as claimed in claim 4, wherein said data processing command triggers said interface means to initiate a document viewing program to open said document.

6. A system as claimed in claim 5, wherein said electronic mail message received at said remote computer appears scrambled to a user of said second remote computer, until said user engages said encryption means, and said encryption means decrypts said electronic mail message.

7. A system as claimed in claim 5, wherein said first computer and second remote computer each comprises a data compression means for compressing and decompressing data communicated between said first computer and second remote computer.

8. A system for receiving data on a secure basis at a first computer from a second remote server computer comprising:
a) an electronic mail means at said first computer adapted to receive electronic mail messages from said remote server computer;
b) an encryption means at said first computer adapted to decrypt encrypted data using an encryption key accessible from said first computer; and
c) an interface means adapted to permit said encryption means and electronic mail means to interface;
wherein said interface means and encryption means are adapted to permit encrypted data received by said first computer from said second remote server computer in the body of said electronic mail message to be decrypted using said encryption key.

9. A system as claimed in claim 8, wherein said electronic mail means comprises a known electronic mail program and said encryption means is adapted to interface with said electronic mail program so as to decrypt data within said body of said electronic mail message opened using said electronic mail program.

10. A system as claimed in claim 9, wherein said first computer further comprises a memory means for storing said encryption key and relating said encryption key to the electronic mail address of said server computer, wherein said encryption means is adapted to retrieve said encryption key corresponding to said server computer from said memory means based on said electronic mail address of said server computer, and decrypting said electronic mail message using said encryption key.

11. A system as claimed in claim 10, wherein said electronic mail message further comprises:
a) a document; and
b) a data processing command that is adapted to trigger said interface means to initiate at least one computer program at said first computer to process said document in accordance with said data processing command.

12. A system as claimed in claim 11, wherein said data processing command triggers said interface means to initiate a document viewing program to open said document.

13. A system as claimed in claim 12, wherein said electronic mail message received at said first computer appears scrambled to a user of said first computer, until said user engages said encryption means, and said encryption means decrypts said electronic mail message.

14. A system as claimed in claim 13, wherein said first computer comprises a data compression means for compressing and decompressing data communicated between said first computer and server computer.

15. A system for delivering data on a secure basis to a plurality of computers comprising:
a) a server computer connected to said plurality of computers via an interconnected network of computers;
b) a memory means comprising information regarding each of said plurality of computers, said information including electronic mail addresses corresponding to each of said plurality of computers, data for delivery to each of said plurality of computers, and an encryption key provided to each of said plurality of computers for encrypting data communicated between said server computer and each of said plurality of computers;
c) an electronic mail means to send electronic mail messages comprising said data to said plurality of computer using said electronic mail addresses;
d) an encryption means adapted to encrypt and decrypt data; and
e) an interface means adapted to permit said encryption means and electronic mail means to interface;
wherein said interface means and encryption means are adapted to permit said data to be encrypted in the body of said electronic mail messages, and decrypted from the body of said electronic mail messages;
and said electronic mail means is adapted to send said electronic mail messages to said plurality of computers, and receive electronic mail messages from said plurality of computers.

16. A system as claimed in claim 15, wherein said electronic mail message further comprises:
a) a document; and
b) a data processing command that is adapted to trigger each of said plurality of computers to initiate at least one computer program at said plurality of computers to process said document in accordance with said data processing command.

17. A system as claimed in claim 16, wherein said data processing command triggers each of said plurality of computers to initiate a document viewing program to open said document.

18. A system as claimed in claim 17, wherein said data sent to each of said plurality of computers appears scrambled to a user of each of said plurality of computers, until said data is decrypted at each of said plurality of computers.

19. A system as claimed in claim 18, wherein said server computer comprises a data compression means for compressing and decompressing data communicated between said server computer and said plurality of computers.

20. A computer product for receiving data on a secure basis at a first computer from a remote server computer comprising:
a) a recording means;
b) means recorded on said recording means for providing instructions to said first computer, wherein said first computer is adapted to provide:
i) an encryption means adapted to encrypt and decrypt data communicated between said first computer and said remote server computer using an encryption key accessible from said first computer; and
ii) an interface means adapted to permit said encryption means to interface with an electronic mail means provided at said first computer for sending and receiving electronic mail messages;
wherein said interface means and encryption means are adapted to permit said encrypted data received by said first computer in the body of an electronic mail message received by said electronic mail means to be decrypted using said encryption key.

21. A computer product for delivering data on a secure basis from a server computer to a plurality of computers, wherein said server computer and plurality of computers are connected via an interconnected network of computers, said computer product comprising:
a) a recording medium
b) means recorded on said recording medium for providing instructions to said server computer such that said server computer is adapted to provide:
i) a memory means comprising information regarding each of said plurality of computers, said information comprising electronic mail addresses corresponding to each of said plurality of computers, data for delivery to each of said plurality of computers, and an encryption key provided to each of said plurality of computers for encrypting data communicated between said server computer and each of said plurality of computers;
ii) an encryption means adapted to encrypt and decrypt data communicated between said server computer and said plurality of computer provided in the body of an electronic mail message; and
iii) an interface means adapted to permit said encryption means to interface with an electronic mail means provided at said server computer for sending and receiving electronic mail messages between said server computer and said plurality of computers;
wherein said interface means and encryption means are adapted to permit said data to be encrypted in the body of said electronic mail messages.

22. A method of communicating data on a secure basis from a first computer to a second remote computer, said method comprising the steps of:
a) providing an electronic mail means at each of said first computer and remote computer for communication of electronic mail therebetween;
b) providing an encryption means at each of said first computer and remote computer for encrypting and decrypting data communicated therebetween by said electronic mail means, using an encryption key accessible from each of said first computer and remote computer;
c) sending an electronic mail message from said first computer to said remote computer by means of said electronic mail means, wherein data is encrypted by said encryption means at said first computer and provided to said remote computer in the body of said electronic mail message;
d) decrypting said data from said body of said electronic mail message by means of said encryption means at said remote computer, using said encryption key.

23. The method claimed in claim 22, comprising the further step of including at said first computer in said encrypted data provided in the body of said electronic mail message a data processing command that is adapted to trigger said remote computer to initiate at least one computer program at said remote computer to process said data in accordance with said data processing command once said encrypted data is decrypted by said encryption means at said remote computer.
